(19) United States
(12) Patent Application Publication
(10) Pub. No.: US 2025/0334206 A1
(43) Pub. Date: Oct. 30, 2025

(54) French Coupler

(71) Applicant: Harold French, Sacramento, CA (US)

(72) Inventor: Harold French, Sacramento, CA (US)

(21) Appl. No.: 18/648,143

(22) Filed: Apr. 26, 2024

(51) Int. Cl. F16L 3/04

(52) U.S. Cl. CPC F16L 3/04

(57) ABSTRACT

The present invention relates to the method and apparatus of connecting conduits. More particularly, the present invention relates to a dual function apparatus that is coupling and supporting the coupled conduit. The coupling apparatus comprises a coupler and a supporting structure. Furthermore, a method of affixing said coupler and said supporting structure is disclosed.

### BACKGROUND OF THE INVENTION

The present invention relates to the method and apparatus of connecting conduits. More particularly, the present invention relates to a dual function apparatus that is coupling and supporting the coupled conduit.

There are garden variety of couplers ranging from a simple fixture to an enhanced coupler with added features. Most of the couplers use additional support apparatus that is separated from the coupler. The present invention combines the function of coupling and the function of attachment to a support structure into a single apparatus.

### SUMMARY OF THE INVENTION

In view of the foregoing background, the present invention offers a new and novel concept that users are able both to couple conduits and to support the coupled conduits with an apparatus. Traditionally, two straps are installed for each coupler for the purpose of protecting the coupling. Such method requires three touches, one for coupling and two for attaching the straps to a support base. With the present invention, the separate steps of coupling and attachment to a supporting structure are combined into a single step speeding up the installation process.

There exist various methods of connecting conduit, such as using couplings, compression connectors, threaded adapters, and welding. After connecting conduits, straps, clamps, or hangers are used to secure the conduit to a stable surface or base such as a wall or a post. This will prevent the conduit from moving or shifting over time. In cases where the coupled conduit is suspended in the air, there exists an additional requirement of protecting the common failure point, which is where two conduits are coupled. The present invention of adding support to the common failure point creates a stronger coupler.

Adding additional attachments to a support structure becomes redundant with this apparatus. The present method supports the structure ab initio. This is not just combining two things; this is a paradigm shift from the concept of coupling and structural support are two different things to the concept of coupling and structural support is one in the same.

This method can be applied to various materials such as steel, aluminum, or PVC, and to conduits of any size.

### BRIEF DESCRIPTION OF DRAWINGS

FIG. 1 is a top view of a conduit coupler and two support straps.

FIG. 2 is a top view of a combined apparatus.

FIG. 3 are various views of a combined apparatus.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiment set forth herein. Rather, these embodiments are provided so that this disclosure will be thorough and complete, and will fully convey the scope of the invention to those skilled in the art.

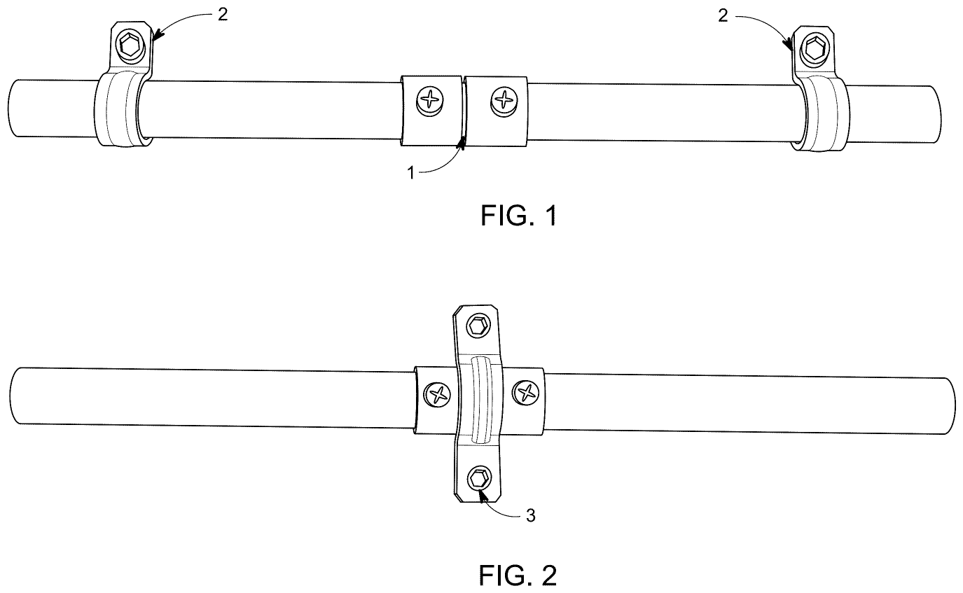

Referring to FIG. 1, the coupler 1 is separate from the strap 2. This is a traditional configuration of a coupler connecting two conduits and two straps supporting the coupled conduits.

FIG. 2 shows a combined coupling apparatus 3 of the present invention. The combined apparatus 3 couples two conduits as well as securing the coupling apparatus to a base.

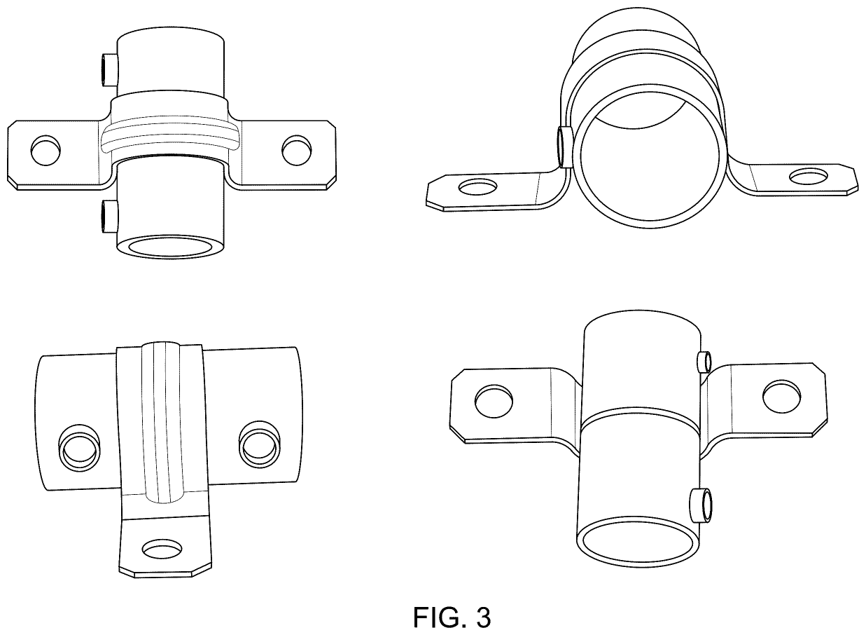

FIG. 3 shows various views of a combined apparatus.

One skilled in the art, after being exposed to the teachings provided in the preceding descriptions and associated drawings, will likely conceive various modifications and alternative embodiments of the invention. Hence, it is important to note that the invention is not limited to the disclosed specific embodiments, and that modifications and alternative embodiments are intended to be encompassed within the scope of the appended claims.

Thus, the scope of the present disclosure is to be determined by the broadest permissible interpretation to the maximum extent allowed by law, of the following claims, and shall not be restricted or limited by the foregoing detailed description.

1. An apparatus for conduit coupling and structural support, comprising: a coupler and a support structure.

2. The coupler of claim 1 connects conduits.

3. The support structure of claim 1 supports the apparatus and load in the apparatus.

4. A method of affixing the coupler of claim 1 to the support structure of claim 1.

5. A method of securing the apparatus of claim 1 to base.
